(19) United States
(12) Patent Application Publication
(10) Pub. No.: US 2018/0317085 A1
(43) Pub. Date: Nov. 1, 2018

(54) DEVICE AUTHENTICATION

(71) Applicant: Avaya Inc., Santa Clara, CA (US)

(72) Inventors: Pratik Ashwath GUJJAR, Davangere (IN); Vignaraj HEGDE, Kaikini (IN)

(73) Assignee: Avaya Inc., Santa Clara, CA (US)

(21) Appl. No.: 15/583,897

(22) Filed: May 1, 2017

(51) Int. Cl. H04W 12/06; H04L 29/06; H04W 12/08

(52) U.S. Cl. CPC H04W 12/06; H04L 63/083; H04L 2463/082; H04W 12/08; H04L 63/107

(57) ABSTRACT

Methods, systems and computer readable media for multifactor authentication and induction by accreditation for wearable device authentication in a network are described.

### TECHNICAL FIELD

Embodiments relate generally to access management, and more particularly, to methods, systems and computer readable media for multifactor authentication and induction by accreditation for device authentication in a network.

### BACKGROUND

Wearable devices, such as head mounted displays (e.g., Google Glass), activity monitors, fitness bands, smart watches, etc., and non-wearable devices, may include specific functionality computational devices that can generate characteristic data about a user from onboard sensors. These devices may make collaboration immersive when connected in a network by virtue of being worn by the user. However, some wearable devices may be incapable of standard inputs (e.g., keyboard/mouse), which can make such wearables difficult to authenticate into a network using traditional methods. Also, authentication based on device IDs in a database can be prohibitive to scaling as new devices are brought in. Further, many devices support a combination of network protocols (e.g., Bluetooth/Wi-Fi), making protocol identification of devices non-uniform.

Embodiments were conceived in light of the above mentioned needs, problems and/or limitations, among other things.

### SUMMARY

In general, some implementations can provide a method comprising determining a user signature based on a sensed parameter of a user, wherein the sensed parameter is obtained via sensor coupled to a first device, and determining a proximity parameter based on a proximity of the first device to a user. The method can also include generating a device signature based on the user signature and the proximity parameter, and generating an access claim based on the user signature and the proximity parameter. The method can further include establishing a connection between the first device and a second device, and providing a time-based access token from the first device to the second device. The method can also include generating an induction token at the second device, wherein the induction token is based on the time-based access token, and providing the induction token to an authentication system in order to authenticate the second device and provide access to an external resource for the second device.

In some implementations, the external system can include a wireless network device. The first device and the second device can both be wearable devices. The first device and the second device can be worn by a same user.

The method can further include providing the access claim from the first device to the authentication system, and when the first device is authenticated by the authentication system, providing the time-based access token from the authentication system to the first device.

The method can also include terminating access to the external resource for the second device when the first device loses a connection with the authentication system or when the proximity parameter becomes null.

Some implementations can include a system. The system can have one or more processors coupled to a nontransitory computer readable medium having stored thereon on software instructions that, when executed by the one or more processors, cause to perform operations. The operations can include determining a user signature based on a sensed parameter of a user, wherein the sensed parameter is obtained via sensor coupled to a first device, and determining a proximity parameter based on a proximity of the first device to a user. The operations can also include generating a device signature based on the user signature and the proximity parameter, and generating an access claim based on the user signature and the proximity parameter. The operations can further include establishing a connection between the first device and a second device, and providing a time-based access token from the first device to the second device. The operations can also include generating an induction token at the second device, wherein the induction token is based on the time-based access token, and providing the induction token to an authentication system in order to authenticate the second device and provide access to an external resource for the second device.

The external system can include a wireless network device. The first device and the second device can both be wearable devices. The first device and the second device can be worn by a same user.

The operations can further include providing the access claim from the first device to the authentication system, and when the first device is authenticated by the authentication system, providing the time-based access token from the authentication system to the first device.

The operations can also include terminating access to the external resource for the second device when the first device loses a connection with the authentication system or when the proximity parameter becomes null.

Some implementations can include a nontransitory computer readable medium having stored thereon software instructions that, when executed by one or more processors, cause the one or more processors to perform operations. The operations can include determining a user signature based on a sensed parameter of a user, wherein the sensed parameter is obtained via sensor coupled to a first device, and determining a proximity parameter based on a proximity of the first device to a user. The operations can also include generating a device signature based on the user signature and the proximity parameter, and generating an access claim based on the user signature and the proximity parameter. The operations can further include establishing a connection between the first device and a second device, and providing a time-based access token from the first device to the second device. The operations can also include generating an induction token at the first device, wherein the induction token is based on the time-based access token, and providing the induction token to a second device that can then, in turn, provide the induction token to an authentication system in order to authenticate the second device and provide access to an external resource for the second device.

The external system can include a wireless network device. The first device and the second device can both be wearable devices. The first device and the second device can be worn by a same user.

The operations can further include providing the access claim from the first device to the authentication system, and when the first device is authenticated by the authentication system, providing the time-based access token from the authentication system to the first device.

The operations can also include terminating access to the external resource for the second device when the first device loses a connection with the authentication system or when the proximity parameter becomes null.

### BRIEF DESCRIPTION OF THE DRAWINGS

FIG. 1 is a diagram of an example wearable authentication environment in accordance with some implementations.

FIG. 2 is a diagram of an example state transition for a primary device in accordance with some implementations.

FIG. 3 is a diagram of an example authentication sequence for a primary device in accordance with some implementations.

FIG. 4 is a diagram of an example state transition for a secondary device in accordance with some implementations.

FIG. 5 is a diagram of an example authentication sequence for a secondary device in accordance with some implementations.

FIG. 6 is a diagram showing example access claim structure in accordance with some implementations.

FIG. 7 is a diagram of an example computing device configured for authenticating wearable devices in accordance with at least one implementation.

### DETAILED DESCRIPTION

In general, a master device can establish a secure connection with a network and then proceed to induce this connection to another device by vouching for the other device regarding authentication into the network. This may make traditional username and password methods of network access/authentication obsolete, owing to the unique and reliable identification of the user by the device. Examples are described herein in terms of wearable devices. However, it will be appreciated that implementations can be used with non-wearable devices as well. In general, a device capable of communicating a valid user signature and a proximity parameter, as discussed herein, can be used in an implementation.

Some implementations exploit sensors on a wearable capable of delivering a characteristic of the user wearing the device. User characteristics can include biometric data that the device can sense. For example, plethymyography readings from an Apple Watch or similar device, as described in U.S. Pub No. 20160296142. In conjunction with this unique identifier is the requirement that the wearable has to be worn by the user for a successful authentication into a network. The former is called the “User Signature” and the latter “Proximity Parameter”. A user signature can be chosen out of the many unique sensor readings that will be generated specifically for the user by the wearable. Proximity parameters could simply be an identifier indicating whether the device is worn, or a relative position of the wearable to a user or other device (e.g., a network access point) or one of the many proximity events that can be picked up from the wearable. Multiple factors used to derive the User Signature and Proximity Parameter, which, when hashed will be called a “Device Signature.” The device signature can then be hashed together with the accesses to be requested for the wearables to generate “Access Claims.”

A wearable delivering this identification to the “Authenticator” (e.g., an authentication system) is considered a “Primary Bidder”. The primary bidder changes state from Naive to Primary after successful authentication of the user against a device signature used to claim access. The primary assumes the state of “Claimant” while approaching the Authenticator for access. Claimant will fall back to Naive if access is denied. If access is granted, claimant is validated by the authenticator and a time-bound access token is granted for policy-based access. Access tokens (or codes) can be be refreshed at unequal intervals of time for continued access to a network. Using unequal periods of time for access token refresh can help improve security. Policy is enforced by communicating access permissions in the time-bound token from the authenticator to the device. In one implementation the token issued would contain policy parameters.

Any additional wearable (e.g., a second wearable device) seeking access to the network can establish a link to the primary wearable device. The primary wearable device now acts as an Accreditation Agent and communicates an induction token (e.g., the time-bound access token) to the second wearable over a secure link. An Induction Token is a means of introducing a wearable into a secure network by a primary wearable that is successfully authenticated to that network by multifactor access verification, thereby securing access for multiple wearables worn by the same user. The second wearable device can start as being naive in the network before being induced as an “Introducee” by the primary. The introducee acknowledges the primary by responding with its own device details to the primary for its optional record keeping. The device signature for the introducee now is devoid of the user signature. Effectively only the proximity parameters of the introducee, along with the access requests are used as “Access Claims”. The token granted to the primary introduces the introducee to the authenticator making him the new “Claimant”. The claimant will use this token, additionally hash it with its own device signature to generate an “Induction Token”, to let know the authenticator of its own details. This maintains the user signature originally derived from the primary and the authenticator identifies the claimant as an induced wearable. The process is intuitively accurate in the way that all devices securing access are worn by the same user. Further authentication is managed as for the primary. Successful accreditation puts the secondary in an access chain.

In the event that the primary device loses connection with the Authenticator, for example because of network outage or authentication failure or because the primary is not being worn anymore leading to a null proximity parameter, secondary devices induced into the network by the primary device will also lose access as the Access Token will no longer be valid. The secondary device itself will have to be worn at all times for a valid proximity parameter, granting it network access. However, a null proximity parameter for a secondary device will not cause any connection loss for the primary device.

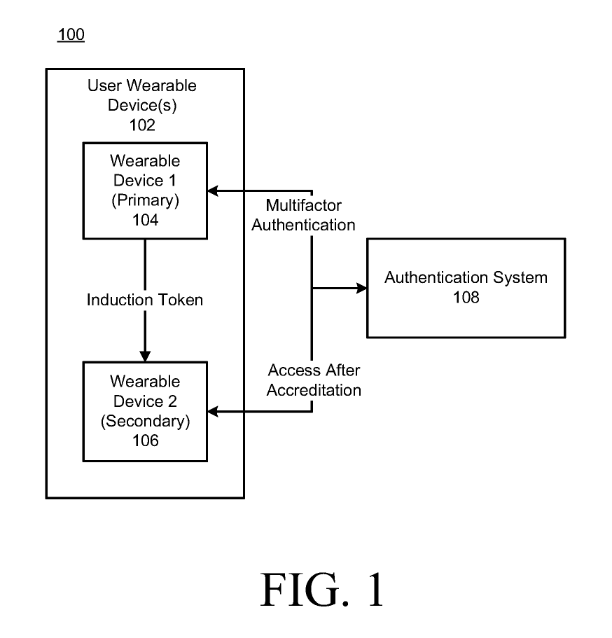

FIG. 1 is a diagram of an example wearable authentication environment 100 in accordance with some implementations. The environment 100 includes a plurality of user wearable devices 102 including a primary device 104 (e.g., a wearable device, other computing device, etc.) and a secondary device 106. The environment 100 also includes an authentication system 108.

In operation, the primary device 104 can be authenticated and transition from naive to primary according to the state transition and authentication sequence described below in greater detail via a multi-factor authentication process. Multifactor authentication can include a standard OTP method and/or one of the available sensor readings in the case of a wearable. Each factor may be weighed individually to determine authenticity and consequently design an access policy. When a second device 106 seeks access to an external resource (e.g., a network), the primary device 104 can provide the secondary device 106 with an induction token (e.g., a time-bound access token) that can be used by the secondary device during its authentication with the authentication system, which can include permitting the secondary device access to the network after an authentication process that is at least partly based on accreditation of the secondary device based on the induction token supplied by the primary wearable device.

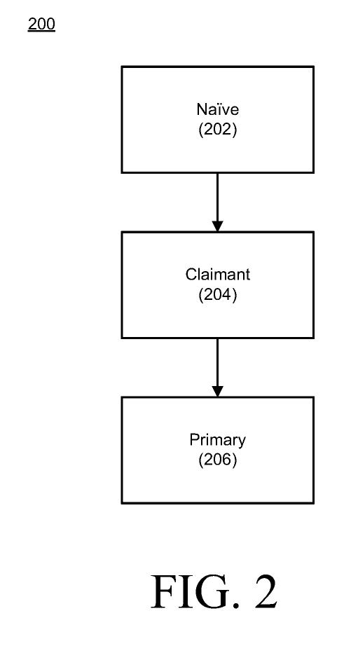

FIG. 2 is a diagram of an example state transition for a primary device in accordance with some implementations. A wearable device can initially be in a naive state 202 and then seek to access an external resource such as a network during a claimant state 204. Once the wearable device has been authenticated (e.g., via a multi-factor authentication process as described herein), the wearable can transition to a primary state 206. Naive to Primary transition may take as long as verification of the user's credentials in the form of the offered multi-factors for the primary device. As the verification is based on multi-factors, limited or policy-based access can be granted as more and more factors get authenticated. Policy can also be set based on the confidence in the validation of these multi-factors.

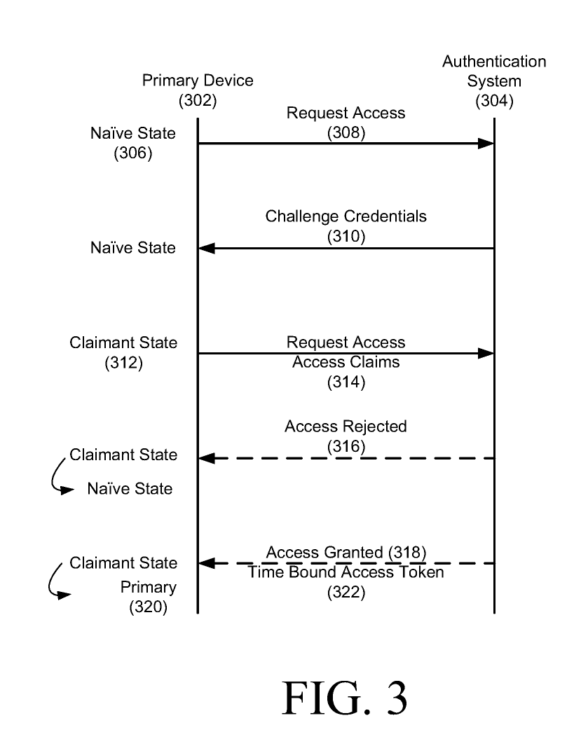

FIG. 3 is a diagram of an example authentication sequence for a primary device in accordance with some implementations. The primary device 302 seeks to be authenticated by an authentication system 304 as part of the primary device seeking access to an external resource such as a network.

Starting in the naive state 306, the primary device 302 requests access (308), which is received by the authentication system 304. The authentication system 304 challenges the credentials (310) of the primary device 302. In response to the challenge, the primary device 302 transitions to the claimant state 312 and requests access accompanied by an access claim 314 (as described herein).

If access is rejected (316), the state of the primary device 302 transition from claimant back to naive. If access is granted 318, the primary device 302 transitions from the claimant state to the primary state 320 and the authentication system provides a time-bound access token 322.

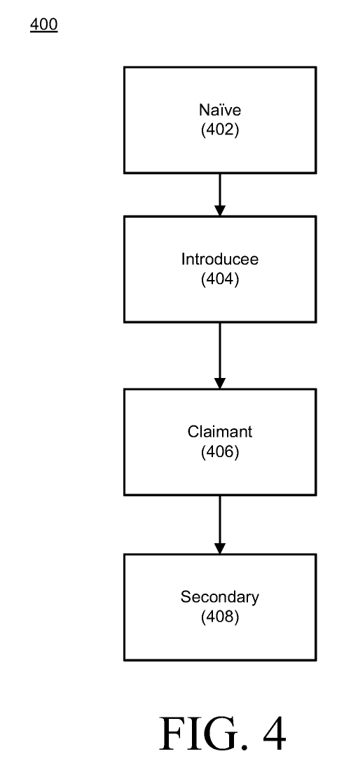

FIG. 4 is a diagram of an example state transition for a secondary device in accordance with some implementations. A secondary wearable device can initially be in a naive state 402 and then transition to the introducee state 404 when the primary device communicates a time bound access token to the secondary device. The secondary device can then transition to the claimant state 406 when the secondary device seeks to access an external resource such as a network by seeking authentication from an authentication system. The secondary device can then transition to secondary state 408 once the secondary device has been authenticated based on the token supplied by the primary device.

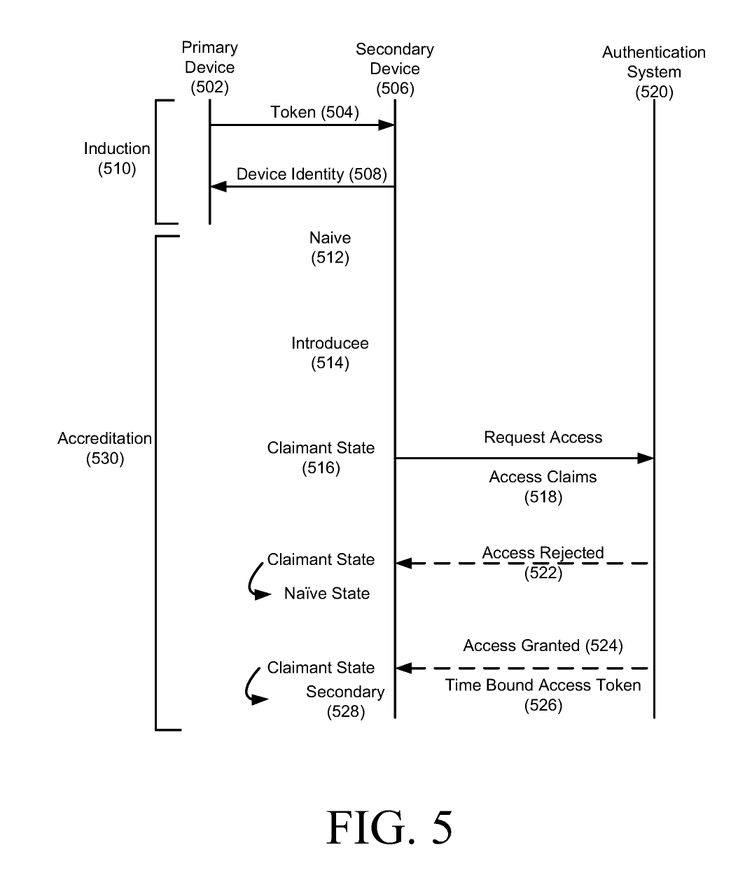

FIG. 5 is a diagram of an example authentication sequence for a secondary device in accordance with some implementations. A primary device 502 provides a token (e.g., time bound access token 504) to a secondary device 506. The secondary device 506 can respond with device identity information 508 as part of an induction phase 510.

The secondary device 506 transitions from a naive state 512 to an introducee state 514 to a claimant state 516 at which point the secondary device 506 requests access and provides access claims to an authentication system 520.

The authentication system 520 can either reject the access request 522 or grant the access request 524. If the access is rejected 522, the secondary device moves from the claimant state back to the naive state. If the access is granted, the authentication system supplies a time bound access token 526 and the secondary device transitions from the claimant state to the secondary state 528.

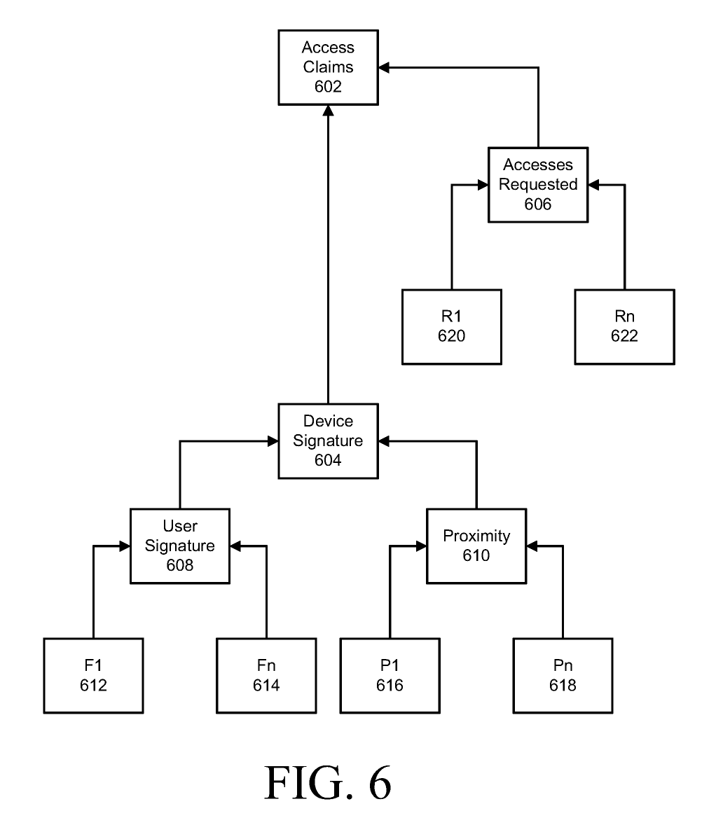

FIG. 6 is a diagram showing example access claim structure in accordance with some implementations. An access claim 602 can be used to request access to the network and can be based on a device signature 604 and one or more requested accesses 606.

The device signature 604 can be based on a user signature 608 and a proximity parameter 610 (e.g., can be a result of a function such as a hash function of the user signature and the proximity parameter). For example, a device signature can represent both the user's credentials/sensor reading and the proximity parameter. For the secondary device, the user signature is derived from the induction token. In some implementations, the proximity parameter can include a generic measurement of the relative distance between the device and the user and, for example, could established by WiFi access point triangulation, BLE triangulation or by heart rate readings when a compatible device is worn.

The user signature 608 can be based on one or more sensed parameters associated with a user (e.g., F1 612-Fn 614). A user signature can include a collection of the multiple factors (sensors readings that can uniquely identify the user). Examples of user signature parameters can include plethymyoography (heart rate characteristic), and electromyography (muscle flex characteristic). The proximity parameter 610 can be based on one or more proximity measures (e.g., P1 616-Pn 618). The requested accesses can include one or more access requests (e.g., R1 620-Rn 622). Proximity parameters can include data such as whether device is worn/not worn, and how close the user is to devices (e.g., via Bluetooth, WiFi triangulation, etc.). Access requests can include a request for access to one or a collection of policies from a host of policies that the network/server can offer.

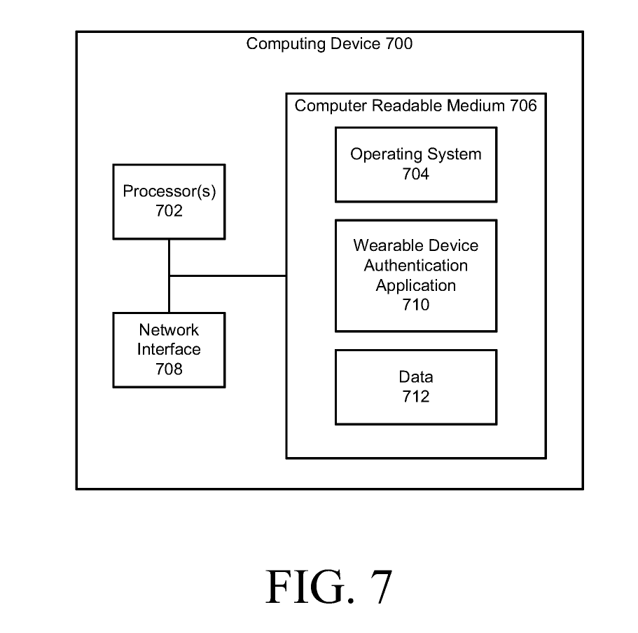

FIG. 7 is a diagram of an example computing device 700 in accordance with at least one implementation. The computing device 700 includes one or more processors 702, nontransitory computer readable medium 706 and network interface 708. The computer readable medium 706 can include an operating system 704, an application 710 for wearable authentication and a data section 712 (e.g., for storing induction tokens, device identity, authentication information, etc.).

In operation, the processor 702 may execute the application 710 stored in the computer readable medium 706. The application 710 can include software instructions that, when executed by the processor, cause the processor to perform operations for wearable authentication in accordance with the present disclosure (e.g., performing one or more of the sequences described above in connection with FIGS. 3 and 5).

The application program 710 can operate in conjunction with the data section 712 and the operating system 704.

Thus, some implementations provide authentication and, in-turn, a collaboration of wearables in a network made possible and seamless by virtue of the wearable being worn by the user and thus delivering a host of user-characteristic data without having to input user credentials through standard input mechanisms. The reliability of this user-characteristic data is leveraged in both identifying the user and then validating the access claim. Multiple wearables can be authenticated into the network simply because they are worn by a same user, making the authentication process intuitively accurate.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for multifactor and induced accreditation for wearable device authentication in a network.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
determining a user signature based on a sensed parameter of a user, wherein the sensed parameter is obtained via sensor coupled to a first device;
determining a proximity parameter based on a proximity of the first device to the user;
generating a device signature based on the user signature and the proximity parameter;
generating an access claim based on the user signature and the proximity parameter;
establishing a connection between the first device and a second device;
providing a time-based access token from the first device to the second device;
generating an induction token at the second device, wherein the induction token is based on the time-based access token; and
providing the induction token to an authentication system in order to authenticate the second device and provide access to an external resource for the second device.

2. The method of claim 1, wherein the proximity parameter includes an indication of whether the first device is being worn by the user.

3. The method of claim 1, wherein the first device and the second device are both wearable devices.

4. The method of claim 1, wherein the first device and the second device are worn by a same user.

5. The method of claim 1, further comprising:
providing the access claim from the first device to the authentication system; and
when the first device is authenticated by the authentication system, providing the time-based access token from the authentication system to the first device.

6. The method of claim 1, further comprising:
terminating access to the external resource for the second device when the first device loses a connection with the authentication system or when the proximity parameter becomes null.

7. A system comprising:
one or more processors coupled to a nontransitory computer readable medium having stored thereon on software instructions that, when executed by the one or more processors, cause to perform operations including:
determining a user signature based on a sensed parameter of a user, wherein the sensed parameter is obtained via sensor coupled to a first device;
determining a proximity parameter based on a proximity of the first device to the user;
generating a device signature based on the user signature and the proximity parameter;
generating an access claim based on the user signature and the proximity parameter;
establishing a connection between the first device and a second device;
providing a time-based access token from the first device to the second device;
generating an induction token at the second device, wherein the induction token is based on the time-based access token; and
providing the induction token to an authentication system in order to authenticate the second device and provide access to an external resource for the second device.

8. The system of claim 7, wherein the proximity parameter includes an indication of whether the first device is being worn by the user.

9. The system of claim 7, wherein the first device and the second device are both wearable devices.

10. The system of claim 7, wherein the first device and the second device are worn by a same user.

11. The system of claim 7, wherein the operations further comprise:
providing the access claim from the first device to the authentication system; and
when the first device is authenticated by the authentication system, providing the time-based access token from the authentication system to the first device.

12. The system of claim 7, further comprising:
terminating access to the external resource for the second device when the first device loses a connection with the authentication system or when the proximity parameter becomes null.

13. A nontransitory computer readable medium having stored thereon software instructions that, when executed by one or more processors, cause the one or more processors to perform operations including:
determining a user signature based on a sensed parameter of a user, wherein the sensed parameter is obtained via sensor coupled to a first device;
determining a proximity parameter based on a proximity of the first device to the user;
generating a device signature based on the user signature and the proximity parameter;
generating an access claim based on the user signature and the proximity parameter;
establishing a connection between the first device and a second device;
providing a time-based access token from the first device to the second device;
generating an induction token at the second device, wherein the induction token is based on the time-based access token; and
providing the induction token to an authentication system in order to authenticate the second device and provide access to an external resource for the second device.

14. The nontransitory computer readable medium of claim 13, wherein the proximity parameter includes an indication of whether the first device is being worn by the user.

15. The nontransitory computer readable medium of claim 13, wherein the first device and the second device are both wearable devices.

16. The nontransitory computer readable medium of claim 13, wherein the first device and the second device are worn by a same user.

17. The nontransitory computer readable medium of claim 13, wherein the operations further comprise:
providing the access claim from the first device to the authentication system; and
when the first device is authenticated by the authentication system, providing the time-based access token from the authentication system to the first device.

18. The nontransitory computer readable medium of claim 13, further comprising:
terminating access to the external resource for the second device when the first device loses a connection with the authentication system or when the proximity parameter becomes null.
